(19) United States
(12) Patent Application Publication
(10) Pub. No.: US 2012/0173624 A1
(43) Pub. Date: Jul. 5, 2012

(54) INTEREST-BASED MEETING SUMMARIZATION

(75) Inventors: Chelsea Christine Beerse, Fairport, NY (US); Patrick Joseph O'Sullivan, Ballsbridge (IE); Jeffrey B. Sloyer, Fishersville, VA (US)

(73) Assignee: International Business Machines Corporation, Armonk, NY (US)

(21) Appl. No.: 12/984,807

(22) Filed: Jan. 5, 2011

(51) Int. Cl. G06F 15/16

(52) U.S. Cl. 709/204

(57) ABSTRACT

A method, computer program product, and system for summarization are described. A method may comprise associating one or more first summary tags with one or more portions of a meeting, based upon, at least in part, a first interest level corresponding to a first user associated with the meeting. The method may further comprise associating one or more second summary tags with the one or more portions of the meeting, based upon, at least in part, a second interest level corresponding to a second user associated with the meeting. The method may also comprise generating a first summary of the one or more portions of the meeting, based upon, at least in part, the one or more first summary tags, and may additionally comprise generating a second summary of the one or more portions of the meeting, based upon, at least in part, the one or more second summary tags.

### BACKGROUND OF THE INVENTION

An individual may miss a recorded meeting and may listen to the recorded meeting at a later time. The individual may also listen to a summarized version of the meeting that may not be as long as the entire recorded meeting. The summary may exclude key parts of the meeting that are of interest to the user.

### BRIEF SUMMARY OF THE INVENTION

In a first embodiment, a method may include associating, via a computing device, one or more first summary tags with one or more portions of a meeting, based upon, at least in part, a first interest level corresponding to a first user associated with the meeting. The method may further include associating, via the computing device, one or more second summary tags with the one or more portions of the meeting, based upon, at least in part, a second interest level corresponding to a second user associated with the meeting. The method may also include generating, via the computing device, a first summary of the one or more portions of the meeting, based upon, at least in part, the one or more first summary tags. The method may additionally include generating, via the computing device, a second summary of the one or more portions of the meeting, based upon, at least in part, the one or more second summary tags, wherein the first summary and the second summary are distinct.

One or more of the following features may be included. The method may include retrieving at least one of the first summary, and the second summary, based upon, at least in part, a position of at least one of the first user, and the second user. The position of at least one of the first user, and the second user, may based upon, at least in part, at least one of a team association, an organizational hierarchy, a corporate directory, a social network, and a trust relationship. The method may also include determining at least one of the first interest level corresponding to the first user associated with the meeting, and the second interest level corresponding to the second user associated with the meeting. At least one of the one or more first summary tags, and the one or more second summary tags, may be associated with the one or more portions of the meeting by at least one of the first user, and the second user.

In some implementations, at least one of the first interest level corresponding to the first user associated with the meeting, and the second interest level corresponding to the second user associated with the meeting, may be determined based upon, at least in part, one or more actions during the meeting by at least one of the first user, and the second user. The one or more actions may include at least one of opening an application, alternating between applications, sending an instant message, making a telephone call, opening an email message, and reading an email message. The meeting may be an e-meeting and may include at least one of a telephonic communication, an instant message communication, a video communication, an audio communication, and a web presentation.

In a second embodiment, a computer program product may reside on a computer readable storage medium and may have a plurality of instructions stored on it. When executed by a processor, the instructions may cause the processor to perform operations including associating one or more first summary tags with one or more portions of a meeting, based upon, at least in part, a first interest level corresponding to a first user associated with the meeting. The operations may further include associating one or more second summary tags with the one or more portions of the meeting, based upon, at least in part, a second interest level corresponding to a second user associated with the meeting. The operations may also include generating a first summary of the one or more portions of the meeting, based upon, at least in part, the one or more first summary tags. The operations may additionally include generating a second summary of the one or more portions of the meeting, based upon, at least in part, the one or more second summary tags, wherein the first summary and the second summary are distinct.

One or more of the following features may be included. The operations may include retrieving at least one of the first summary, and the second summary, based upon, at least in part, a position of at least one of the first user, and the second user. The position of at least one of the first user, and the second user, may based upon, at least in part, at least one of a team association, an organizational hierarchy, a corporate directory, a social network, and a trust relationship. The operations may also include determining at least one of the first interest level corresponding to the first user associated with the meeting, and the second interest level corresponding to the second user associated with the meeting. At least one of the one or more first summary tags, and the one or more second summary tags, may be associated with the one or more portions of the meeting by at least one of the first user, and the second user.

In some implementations, at least one of the first interest level corresponding to the first user associated with the meeting, and the second interest level corresponding to the second user associated with the meeting, may be determined based upon, at least in part, one or more actions during the meeting by at least one of the first user, and the second user. The one or more actions may include at least one of opening an application, alternating between applications, sending an instant message, making a telephone call, opening an email message, and reading an email message. The meeting may be an e-meeting and may include at least one of a telephonic communication, an instant message communication, a video communication, an audio communication, and a web presentation.

In a third embodiment, a computing system is provided. The computing system may include at least one processor and at least one memory architecture coupled with the at least one processor. The computing system may also include a first software module executed on the at least one processor and the at least one memory architecture, wherein the first software module is configured to associate one or more first summary tags with one or more portions of a meeting, based upon, at least in part, a first interest level corresponding to a first user associated with the meeting. Further, the computing system may include a second software module configured to associate one or more second summary tags with the one or more portions of the meeting, based upon, at least in part, a second interest level corresponding to a second user associated with the meeting. Additionally, the computing system may include a third software module configured to generate a first summary of the one or more portions of the meeting, based upon, at least in part, the one or more first summary tags. The computing system may also include a fourth software module configured to generate a second summary of the one or more portions of the meeting, based upon, at least in part, the one or more second summary tags, wherein the first summary and the second summary are distinct.

One or more of the following features may be included. The computing system may also include a fifth software module configured to retrieve at least one of the first summary, and the second summary, based upon, at least in part, a position of at least one of the first user, and the second user. The position of at least one of the first user, and the second user, may based upon, at least in part, at least one of a team association, an organizational hierarchy, a corporate directory, a social network, and a trust relationship. The computing system may further include a sixth software module configured to determine at least one of the first interest level corresponding to the first user associated with the meeting, and the second interest level corresponding to the second user associated with the meeting.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of an interest-based meeting summarization process coupled to a distributed computing network;

FIG. 2 is a flowchart of the interest-based meeting summarization process of FIG. 1;

FIG. 3 is an exemplary graphical user interface which may be associated with the interest-based meeting summarization process of FIG. 1;

FIG. 4 is also an exemplary graphical user interface which may be associated with the interest-based meeting summarization process of FIG. 1;

FIG. 5 is an exemplary summary which may be associated with the interest-based meeting summarization process of FIG. 1;

FIG. 6 is also an exemplary summary which may be associated with the interest-based meeting summarization process of FIG. 1;

FIG. 7 is an exemplary graphical user interface which may be associated with the interest-based meeting summarization process of FIG. 1; and

FIG. 8 is an exemplary computer screen which may be associated with the interest-based meeting summarization process of FIG. 1.

### DETAILED DESCRIPTION OF THE INVENTION

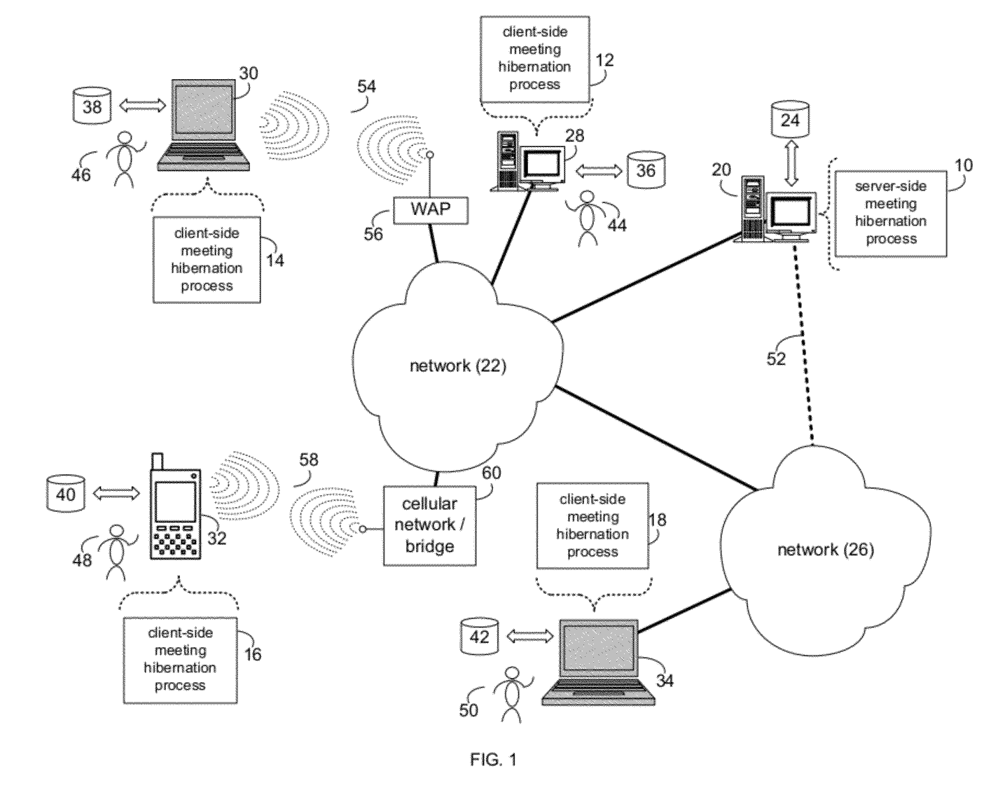

Referring to FIGS. 1 & 2, there is shown an interest-based meeting summarization process 10. As will be discussed below, interest-based meeting summarization process 10 may associate 100 one or more first summary tags with one or more portions of a meeting, based upon, at least in part, a first interest level corresponding to a first user associated with the meeting. Interest-based meeting summarization process 10 may also associate 102 one or more second summary tags with the one or more portions of the meeting, based upon, at least in part, a second interest level corresponding to a second user associated with the meeting.

The interest-based meeting summarization (IBMS) process may be a server-side process (e.g., server-side IBMS process 10), a client-side process (e.g., client-side IBMS process 12, client-side IBMS process 14, client-side IBMS process 16, or client-side IBMS process 18), or a hybrid server-side / client-side process (e.g., the combination of server-side IBMS process 10 and one or more of client-side IBMS processes 12, 14, 16, 18).

Server-side IBMS process 10 may reside on and may be executed by server computer 20, which may be connected to network 22 (e.g., the Internet or a local area network). Examples of server computer 20 may include, but are not limited to: a personal computer, a server computer, a series of server computers, a mini computer, and/or a mainframe computer. Server computer 20 may be a web server (or a series of servers) running a network operating system, examples of which may include but are not limited to: Microsoft® Windows Server®; Novell® Netware®; or Red Hat® Linux®, for example.

The instruction sets and subroutines of server-side IBMS process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); and a read-only memory (ROM).

Server computer 20 may execute a web server application, examples of which may include but are not limited to: Microsoft® IIS, Novell® Web Server, or Apache® Web Server, that allows for access to server computer 20 (via network 22) using one or more protocols, examples of which may include but are not limited to HTTP (i.e., HyperText Transfer Protocol), SIP (i.e., session initiation protocol), and the Lotus® Sametime® VP protocol. Network 22 may be connected to one or more secondary networks (e.g., network 26), examples of which may include but are not limited to: a local area network; a wide area network; or an intranet, for example.

Client-side IBMS processes 12, 14, 16, 18 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 22 and/or network 26 and may each execute an operating system, examples of which may include but are not limited to Microsoft® Windows®, Microsoft Windows CE®, Red Hat® Linux®, or a custom operating system.

The instruction sets and subroutines of client-side IBMS processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Client-side IBMS processes 12, 14, 16, 18 and/or server-side IBMS process 10 may be processes that run within (i.e., are part of) a recording and/or summarizing application. Alternatively, client-side IBMS processes 12, 14, 16, 18 and/or server-side IBMS process 10 may be stand-alone applications that work in conjunction with the recording and/or summarizing application. One or more of client-side IBMS processes 12, 14, 16, 18 and server-side IBMS process 10 may interface with each other (via network 22 and/or network 26).

Users 44, 46, 48, 50 may access server-side IBMS process 10 directly through the device on which the client-side IBMS process (e.g., client-side IBMS processes 12, 14, 16, 18) is executed, namely client electronic devices 28, 30, 32, 34, for example. Users 44, 46, 48, 50 may access server-side IBMS process 10 directly through network 22 and/or through secondary network 26. Further, server computer 20 (i.e., the computer that executes server-side IBMS process 10) may be connected to network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, 802.11n, Wi-Fi, and/or Bluetooth device that is capable of establishing wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### The Interest-Based Meeting Summarization Process

For the following discussion, server-side IBMS process 10 will be described for illustrative purposes. It should be noted that client-side IBMS process 12 may be incorporated into server-side IBMS process 10 and may be executed within one or more applications that allow for communication with client-side IBMS process 12. However, this is not intended to be a limitation of this disclosure, as other configurations are possible (e.g., stand-alone, client-side IBMS processes and/or stand-alone server-side IBMS processes.) For example, some implementations may include one or more of client-side IBMS processes 14, 16, 18 in place of or in addition to client-side IBMS process 12.

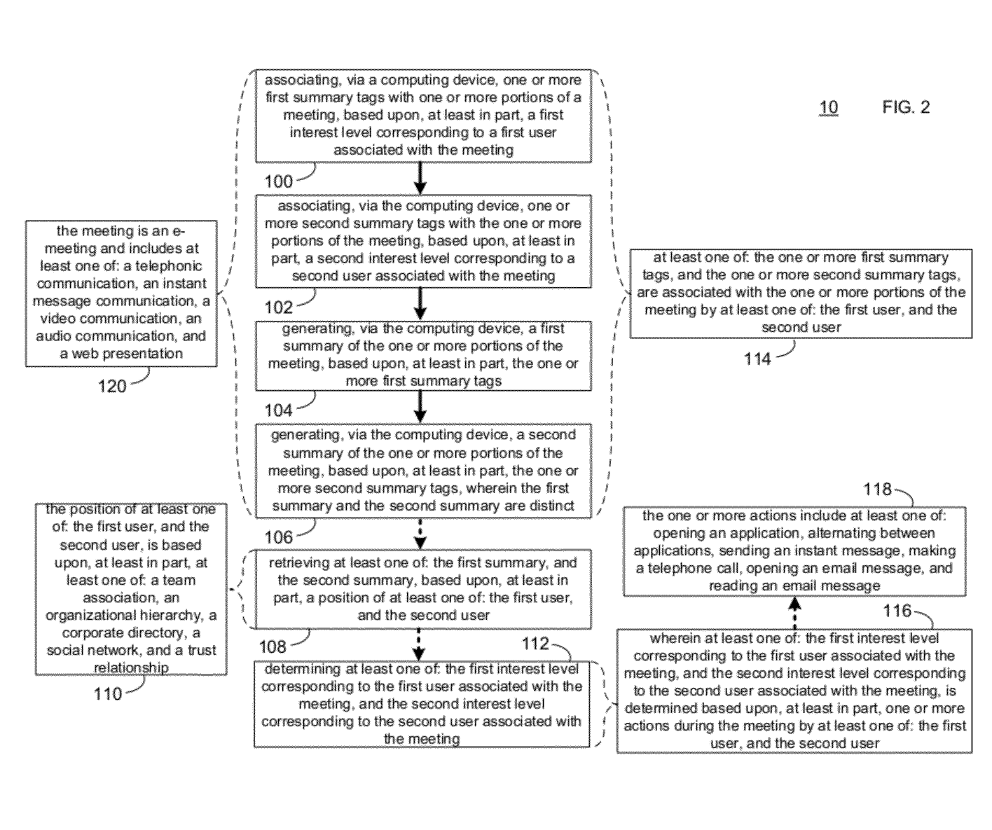

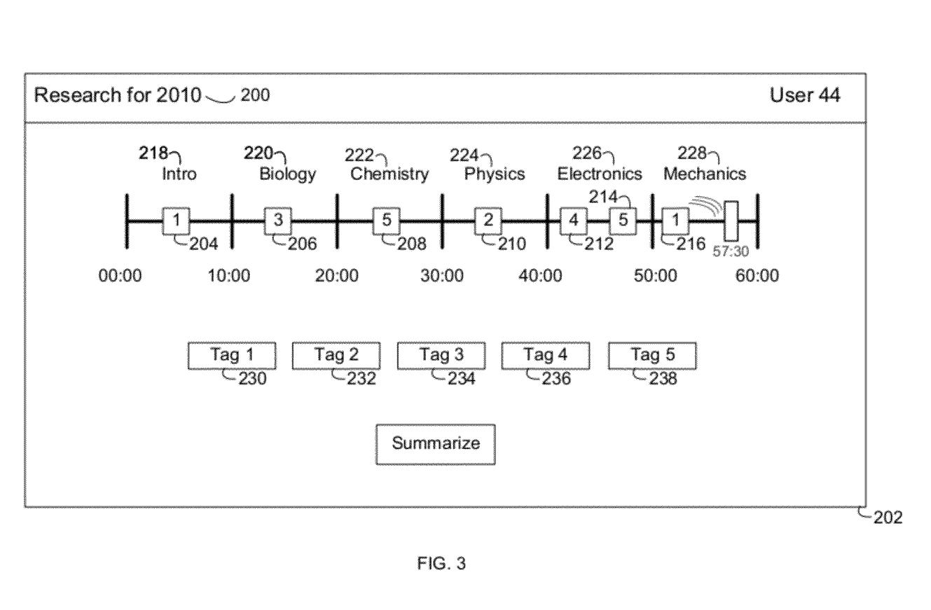

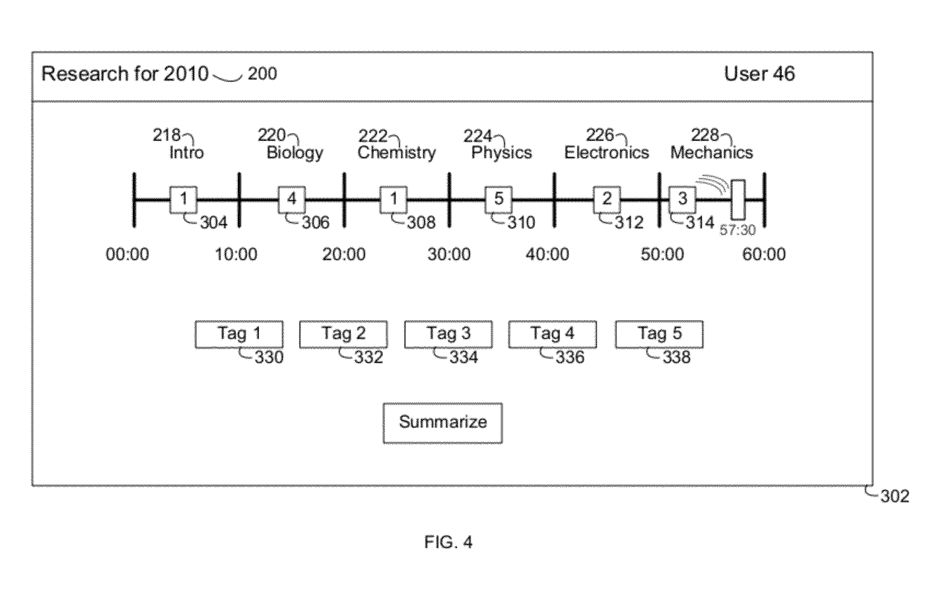

Referring now to FIGS. 1-3, IBMS process 10 may associate 100 one or more first summary tags (e.g., tags 204-216) with one or more portions (e.g., portions 218-228) of a meeting (e.g., meeting 200) based upon, at least in part, a first interest level (e.g., interest level “5” associated with tag 208) corresponding to a first user (e.g., user 44) associated with the meeting (e.g., meeting 200). Meeting 200 may be a meeting, presentation, or other type of collaborative gathering. Further, meeting 200 may be attended online, and audio associated with meeting 200 may be broadcasted to one or more attendees (e.g., users 44, 46). For example, audio associated with meeting 200 may be streamed to many attendees who may not be present at the meeting, such as user 44 and/or user 46. Referring now also to FIG. 4, IBMS process may also associate 102 one or more second summary tags (e.g., tags 304-314) with the one or more portions (e.g., portions 218-228) of the meeting (e.g., meeting 200), based upon, at least in part, a second interest level (e.g., interest level “5” associated with tag 310) corresponding to a second user (e.g., user 46) associated with the meeting (e.g., meeting 200).

At least one of the one or more first summary tags (e.g., tags 204-216), and the one or more second summary tags (e.g., tags 304-314), may be associated 114 with the one or more portions (e.g., portions 218-228) of meeting 200 by at least one of the first user (e.g., user 44), and the second user (e.g., user 46). User 44 and/or user 46 may listen to audio associated with meeting 200 via an audio application that may render audio broadcasted and/or steamed from meeting 200. The audio application may be controlled by user 44 and/or user 46 via a graphical user interface (GUI) (e.g., GUI 202 and/or GUI 302). For example, while listening to portion 218 of meeting 200, user 44 may select one or more of buttons 230-238 in order to indicate an interest level (e.g., interest levels “1” through “5” associated with buttons 230-238) of user 44 in connection with portion 218. Similarly, while listening to portion 224 of meeting 200, user 46 may select one or more of buttons 330-338 in order to indicate an interest level (e.g., interest levels “1” through “5” associated with buttons 330-338) of user 46 in connection with portion 224.

Interest levels 1-5 may correspond to a scale indicating how interesting, relevant, and/or important user 44 and/or user 46 find a portion of meeting 200. For example, “1” may correspond to not interesting, relevant, and/or important, “2” may correspond to slightly interesting, relevant, and/or important, “3” may correspond to interesting, relevant, and/or important, “4” may correspond to moderately interesting, relevant, and/or important, and “5” may correspond to highly interesting, relevant, and/or important. In this way, the interest levels 1-5 may indicate both positive and negative interest levels of users regarding different portions (e.g., portions 218-228) of meeting 200. It should be noted that the interest levels above are discussed for exemplary purposes only. For example, IBMS 10 may allow users to select more or less tags associated with more interest levels or less interest levels, based upon, at least in part, the level of granularity desired in associating interest levels with portions (e.g., portions 218-228) of meetings (e.g., meeting 200).

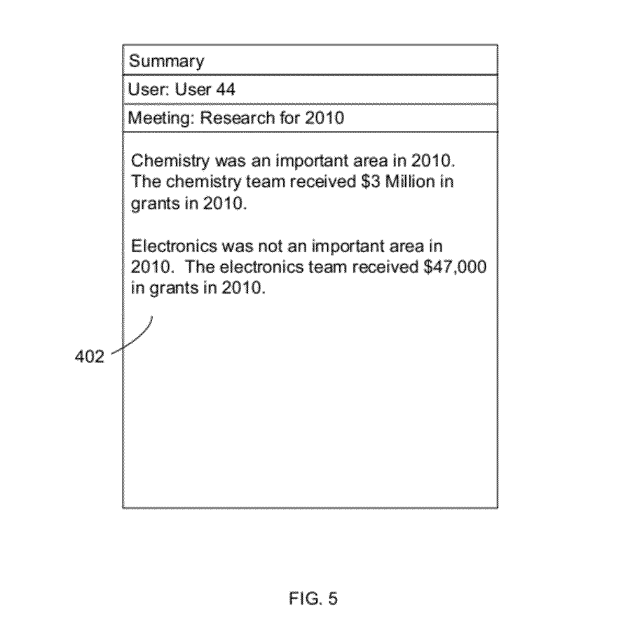

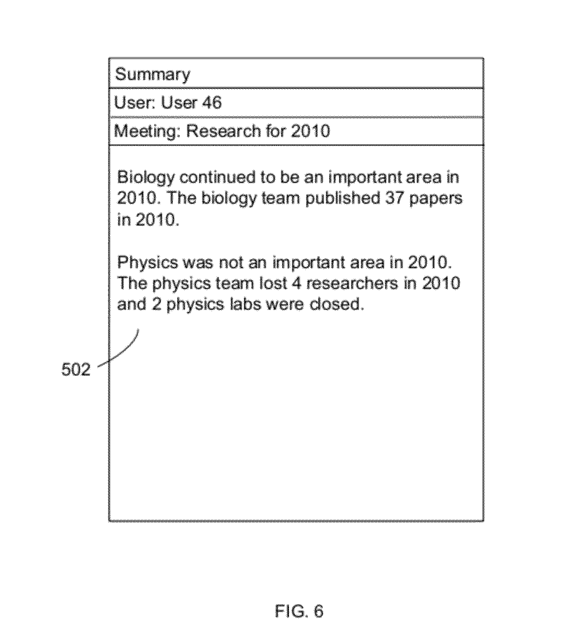

Referring now also to FIGS. 5 and 6, and continuing with the above example, IBMS process 10 may generate 104 a first summary (e.g., summary 402) of the one or more portions (e.g., portions 218-228) of meeting 200, based upon, at least in part, the one or more first summary tags (e.g., tags 204-216). Further, IBMS process 10 may generate 106 a second summary (e.g., summary 502) of the one or more portions (e.g., portions 218-228) of meeting 200, based upon, at least in part, the one or more second summary tags (e.g., tags 304-314). Further, summary 402 and summary 502 may be distinct. In other words, IBMS process 10 may allow one or more users (e.g., user 44 and/or user 46) to generate two different summaries (e.g., summary 402 and summary 502) based upon, at least in part, their different levels of interest corresponding to one or more portions (e.g., portions 218-228) of meeting 200. In this way, IBMS process 10 may use one or more tags (e.g., tags 204-216 and/or tags 304-314) that may indicate an interest level of user 44 and/or user 46 related to one or more portions (e.g., portions 218-228) of meeting 200 to generate user-tailored summaries for two or more users that may be interested in different portions of meeting 200. For example, user 44 may desire a summary that summarizes only portions of meeting 200 tagged with an interest level of “4” or above, by user 44.

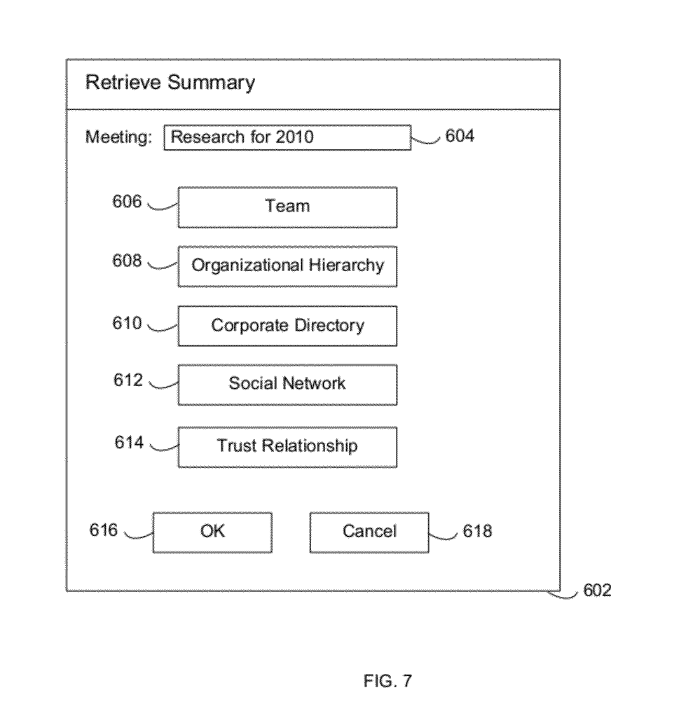

Referring now to FIG. 7, IBMS process 10 may retrieve 108 at least one of the first summary (e.g., summary 402), and the second summary (e.g., summary 502), based upon, at least in part, a position of at least one of the first user (e.g., user 44), and the second user (e.g., user 46). Further, the position of at least one of the first user (e.g., user 44), and the second user (e.g., user 46), may be (110) based upon, at least in part, at least one of a team association, an organizational hierarchy, a corporate directory, a social network, and a trust relationship. For example, assume users 48 and 50 were unable to attend meeting 200. User 48 and/or user 50 may need to catch up on meeting 200 but may not have enough time to listen to recording of meeting 200 in its entirety. Further, user 48 may only be interested in a portion of meeting 200. Assume for illustrative purposes that user 48 is on the chemistry team. As such, user 48 may only be interested in portions of meeting 200 that are relevant to the chemistry team. Assume also for illustrative purposes that user 44 is also on the chemistry team. User 48 may thus be interested in one or more portions of meeting 200 that user 44 was interested in. User 48 may use GUI 602, which may be rendered by IBMS process 10, to retrieve summary 402, since summary 402 may have been tailored by IBMS process 10 to user 44's interest. Summary 402 may be stored (e.g., on a server) for a period of time so that it may be retrieved by one or more users (e.g., user 48). In this way, user 48 may benefit from summary 402, which may have been tailored by IBMS process 10 to user 44's interest.

In another example, user 48 and/or user 50 may attend meeting 200 late and may miss one or more beginning portions of meeting 200. User 48 and/or user 50 may wish to catch up on the one or more beginning portions of meeting 200 before joining the rest of meeting 200. In this situation, user 48 and/or user 50 may retrieve summaries of meeting 200 in a manner similar to that described above, for the portions of meeting 200 they may have missed to that point. In other words, IBMS process 10 may generate summaries before meeting 200 is complete so partial summaries may be retrieved by users who may be late in attending meeting 200, such as user 48 and/or user 50.

Continuing with the above example, GUI 602 may allow user 48 to retrieve a summary tailored to user 48's interest by allowing user 48 to specify various parameters. For example, as discussed above, if user 48 is interested in a summary tailored to someone on the chemistry team, user 48 may enter “Research for 2010” in field 604 to designate meeting 200, and may select button 606 via GUI 602. In response, IBMS process 10 may render a popup interface (not shown) that may allow user 48 to select summary 402 generated based upon, at least in part, user 44's interest. User 48 may select button 616 to retrieve summary 402, or may select button 618 to cancel.

In another example, assume for illustrative purposes that user 46 is a supervisor of user 50. User 50 may be interested in a summary generated by IBMS process 10 tailored to user 46's interest. User 50 may enter “Research for 2010” in field 604 to designate meeting 200, and may select button 608 via GUI 602. In response, IBMS process 10 may render a popup interface (not shown) that may allow user 50 to select a summary associated with one or more of user 50's supervisors and/or managers based upon, at least in part, an organizational hierarchy. As such, the popup interface (not shown), may allow user 50 to select summary 502 generated based upon, at least in part, user 46's interest. User 50 may select button 616 to retrieve summary 502, or may select button 618 to cancel. In this way, user 48 and/or user 50 may also select one or more of buttons 610, 612, and 614 in order to specify one or more summaries of meeting 200 that they may wish to retrieve based upon, at least in part, the interest levels of other users in a corporate directory, a social network associated with user 48 and/or user 50, and/or a trust relationship associated with user 48 and/or user 50.

While meeting 200 has been described above as being a meeting that may include broadcasted and/or steamed audio, other variations are possible. For example, meeting 200 may be an e-meeting and may include (120) at least one of a telephonic communication, an instant message communication, a video communication, an audio communication, and a web presentation. IBMS process 10 may be associated with a collaborative meeting application, and may allow one or more users to tag portions of a telephonic communication, an instant message communication, a video communication, an audio communication, and/or a web presentation based upon, at least in part, an interest level. IBMS process 10 may provide a summary of the one or more communications of the e-meeting in a manner similar to that described above based upon, at least in part, the tagged portions. Further, while summaries 402 and 502 are shown in FIG. 5 and FIG. 6, respectively, as text summaries, other variations are possible. For example, IBMS process 10 may also generate audio summaries based upon, at least in part, the tagged portions of a meeting (e.g., meeting 200).

Additionally, while the one or more first summary tags (e.g., tags 204-216), and the one or more second summary tags (e.g., tags 304-314), have been described above as being associated with the one or more portions (e.g., portions 218-228) of meeting 200 by at least one of user 44 and user 46, other configurations are possible. For example, in an implementation, IBMS process 10 may determine 112 at least one of the first interest level (e.g., interest level “1” associated with tag 216 and portion 228) corresponding to the first user (e.g., user 44) associated with the meeting (e.g., meeting 200), and the second interest level (e.g., interest level “3” associated with tag 314 and portion 228) corresponding to the second user (e.g., user 46) associated with the meeting (e.g., meeting 200). IBMS process 10 may also determine the first interest level and/or the second interest level without a tag selection from the user.

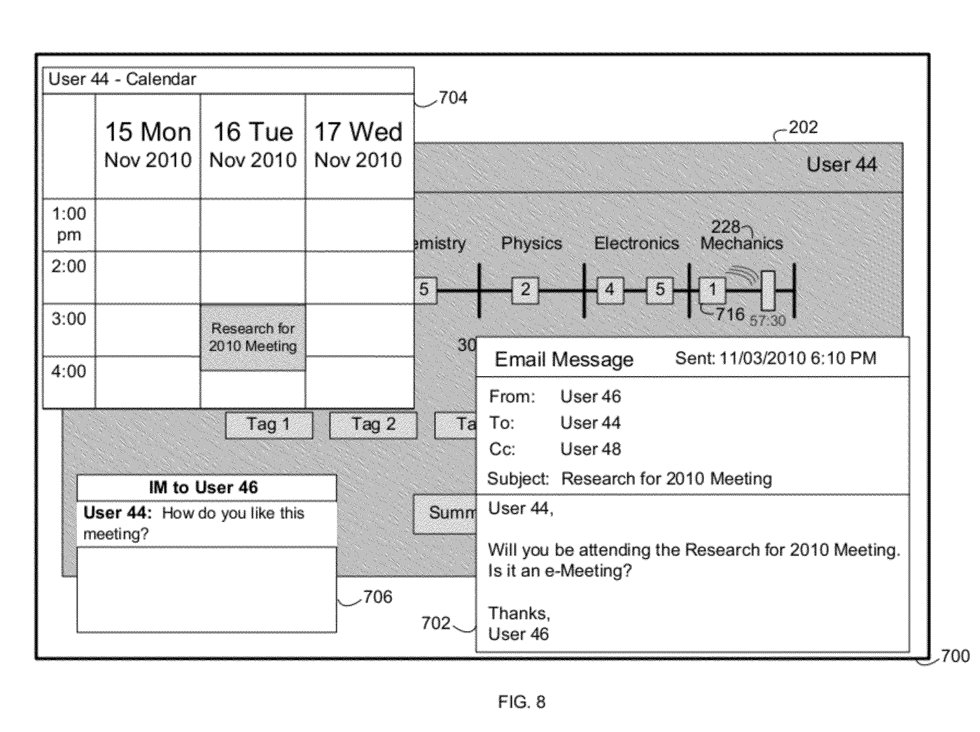

Continuing now with the above example, and referring also to FIG. 8, user 44 may view computer screen 700. Computer screen 700 may allow a user (e.g., user 44 and/or user 46) to interface with a client electronic device (e.g., client electronic devices 28, 30, 32, 34) through which user 44 and/or user 46 may attend an e-meeting (e.g., meeting 200). As discussed above, user 44 and/or user 46 may use GUI 202 and/or GUI 302, respectively, to control an audio application that may render audio broadcasted and/or steamed in connection with meeting 200. While attending meeting 200 online and/or listening to audio related to meeting 200 via the audio application controlled through GUI 202 and/or GUI 302, user 44 and/or user 46 may interact with other applications used by user 44 and/or user 46 on the client electronic device (e.g., client electronic devices 28, 30, 32, 34). User 44 and/or user 46 may take one or more actions related to one or more of these other applications. At least one of the first interest level (e.g., interest level “1” associated with tag 216 and portion 228) corresponding to the first user (e.g., user 44) associated with meeting 200, and the second interest level (e.g., interest level “3” associated with tag 314 and portion 228) corresponding to the second user (e.g., user 46) associated with meeting 200, may be determined (116) based upon, at least in part, one or more actions during meeting 200 by at least one of the first user (e.g., user 44), and the second user (e.g., user 46). The one or more actions may include (118) at least one of opening an application, alternating between applications, sending an instant message (e.g., IM 706), making a telephone call, opening an email message (e.g., email 702), and reading an email message (e.g., email 702).

Assume for illustrative purposes that user 44 becomes uninterested in meeting 200 while listening to audio related to meeting 200 through the audio application. For example, while listening to audio related to meeting 200 via the audio application controlled through GUI 202, user 44 may open an email application and view email 702. Further, user 44 may alternate between the email application and GUI 202. Also, while listening to audio related to meeting 200 via the audio application controlled through GUI 202, user 44 may open a calendaring and scheduling application and view calendar 704. Further user 44 may alternate between the calendaring and scheduling application and GUI 202. User 44 may then wish to communicate with user 46 and may open an instant messaging application to send user 46 instant message (IM) 706. User 44 may alternate between the instant messaging application and GUI 202. Based upon, at least in part, one or more of the actions described above taken by user 44 while listening to audio related to meeting 200 via the audio application controlled through GUI 202, IBMS process 10 may determine (116) that user 44 is uninterested in meeting 200. If user 44 takes one or more of these actions while listening to, for example, portion 228 of meeting 200, IBMS process 10 may determine that user 44 is uninterested in portion 228 of meeting 200. As such, IBMS process 10 may associate portion 228 with tag 716 indicating that user 44 may have an interest level of “1” associated with portion 228. In other words, IBMS process 10 may associate portion 228 with tag 716 without input from user 44.

In an implementation, IBMS process 10 may associate portion 228 with tag 716 based upon, at least in part, a z-order change associated with GUI 202. For example, if user 44 changes the z-order associated with GUI 202 from the front-most window to the back-most window of computer screen 700, IBMS process 10 may associate the portion of meeting 200 currently being listened to by user 44 with a negative interest level (e.g., with tag 716). Similarly, if a new portion of meeting 200 begins and user 44 changes the z-order of GUI 202 back to the front-most window, IBMS process 10 may associate the new portion of meeting 200 with a positive interest level (e.g., a tag corresponding to a higher interest level).

While IBMS process 10 is discussed above in the context of users 44, 46, 48, and 50, IBMS process 10 may allow any number of users to associate tags with portions of meetings and retrieve summaries of the meetings. For example, meeting 200 may include 1000 attendees and any number of those attendees may tag portions of meeting 200. Assume 40 attendees of meeting 200 are on the chemistry team. User 48 may then wish to retrieve summaries of portions of meeting 200 tagged by chemistry attendees that indicate an average interest level of higher than “3”. Similarly, assume that 3 of user 50's supervisors attend meeting 200. User 50 may then which to retrieve summaries of portions of meeting 200 tagged by user 50's supervisors that indicate an average interest level of higher than “2”.

It should be noted that while IBMS process 10 is discussed above as being used for summarization purposes, other variations are possible. For example, assume meeting 200 was a presentation given by one or more presenters. One of the presenters may wish to go back and review portions of the presentation that were tagged by attendees indicating an interest level of less than “2”. Further, one of the presenters may wish to go back and view portions of the presentation that were tagged by attendees on the presenter's team indicating an interest level of “5”. In this way, IBMS process 10 may allow presenters to go back and review portions of presentations that were tagged indicating various interest levels by various groups of attendees.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (i.e., a client electronic device), partly on the user's computer, as a stand-alone software package, partly on the user's computer and partly on a remote computer or entirely on the remote computer or server (i.e., a server computer). In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Further, one or more blocks shown in the block diagrams and/or flowchart illustration may not be performed in some implementations or may not be required in some implementations. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A number of embodiments and implementations have been described. Nevertheless, it will be understood that various modifications may be made. Accordingly, other embodiments and implementations are within the scope of the following claims.

What is claimed is:

1. A method comprising:
associating, via a computing device, one or more first summary tags with one or more portions of a meeting, based upon, at least in part, a first interest level corresponding to a first user associated with the meeting;
associating, via the computing device, one or more second summary tags with the one or more portions of the meeting, based upon, at least in part, a second interest level corresponding to a second user associated with the meeting;
generating, via the computing device, a first summary of the one or more portions of the meeting, based upon, at least in part, the one or more first summary tags; and
generating, via the computing device, a second summary of the one or more portions of the meeting, based upon, at least in part, the one or more second summary tags, wherein the first summary and the second summary are distinct.

2. The method of claim 1, further comprising:
retrieving at least one of: the first summary, and the second summary, based upon, at least in part, a position of at least one of: the first user, and the second user.

3. The method of claim 2, wherein the position of at least one of: the first user, and the second user, is based upon, at least in part, at least one of: a team association, an organizational hierarchy, a corporate directory, a social network, and a trust relationship.

4. The method of claim 1, further comprising:
determining at least one of: the first interest level corresponding to the first user associated with the meeting, and the second interest level corresponding to the second user associated with the meeting.

5. The method of claim 1, wherein at least one of: the one or more first summary tags, and the one or more second summary tags, are associated with the one or more portions of the meeting by at least one of: the first user, and the second user.

6. The method of claim 4, wherein at least one of: the first interest level corresponding to the first user associated with the meeting, and the second interest level corresponding to the second user associated with the meeting, is determined based upon, at least in part, one or more actions during the meeting by at least one of: the first user, and the second user.

7. The method of claim 6, wherein the one or more actions include at least one of: opening an application, alternating between applications, sending an instant message, making a telephone call, opening an email message, and reading an email message.

8. The method of claim 1, wherein the meeting is an e-meeting and includes at least one of: a telephonic communication, an instant message communication, a video communication, an audio communication, and a web presentation.

9. A computer program product residing on a computer readable storage medium having a plurality of instructions stored thereon, which, when executed by a processor, cause the processor to perform operations comprising:
associating, via a computing device, one or more first summary tags with one or more portions of a meeting, based upon, at least in part, a first interest level corresponding to a first user associated with the meeting;
associating, via the computing device, one or more second summary tags with the one or more portions of the meeting, based upon, at least in part, a second interest level corresponding to a second user associated with the meeting;
generating, via the computing device, a first summary of the one or more portions of the meeting, based upon, at least in part, the one or more first summary tags; and
generating, via the computing device, a second summary of the one or more portions of the meeting, based upon, at least in part, the one or more second summary tags, wherein the first summary and the second summary are distinct.

10. The computer program product of claim 9, further comprising instructions for:
retrieving at least one of: the first summary, and the second summary, based upon, at least in part, a position of at least one of: the first user, and the second user.

11. The computer program product of claim 10, wherein the position of at least one of: the first user, and the second user, is based upon, at least in part, at least one of: a team association, an organizational hierarchy, a corporate directory, a social network, and a trust relationship.

12. The computer program product of claim 9, further comprising instructions for:
determining at least one of: the first interest level corresponding to the first user associated with the meeting, and the second interest level corresponding to the second user associated with the meeting.

13. The computer program product of claim 9, wherein at least one of: the one or more first summary tags, and the one or more second summary tags, are associated with the one or more portions of the meeting by at least one of: the first user, and the second user.

14. The computer program product of claim 12, wherein at least one of: the first interest level corresponding to the first user associated with the meeting, and the second interest level corresponding to the second user associated with the meeting, is determined based upon, at least in part, one or more actions during the meeting by at least one of: the first user, and the second user.

15. The computer program product of claim 14, wherein the one or more actions include at least one of: opening an application, alternating between applications, sending an instant message, making a telephone call, opening an email message, and reading an email message.

16. The computer program product of claim 9, wherein the meeting is an e-meeting and includes at least one of: a telephonic communication, an instant message communication, a video communication, an audio communication, and a web presentation.

17. A computing system comprising:
at least one processor;
at least one memory architecture coupled with the at least one processor;
a first software module executed on the at least one processor and the at least one memory architecture, wherein the first software module is configured to associate one or more first summary tags with one or more portions of a meeting, based upon, at least in part, a first interest level corresponding to a first user associated with the meeting;
a second software module executed on the at least one processor and the at least one memory architecture, wherein the second software module is configured to associate one or more second summary tags with the one or more portions of the meeting, based upon, at least in part, a second interest level corresponding to a second user associated with the meeting;
a third software module executed on the at least one processor and the at least one memory architecture, wherein the third software module is configured to generate a first summary of the one or more portions of the meeting, based upon, at least in part, the one or more first summary tags; and
a fourth software module executed on the at least one processor and the at least one memory architecture, wherein the fourth software module is configured to generate a second summary of the one or more portions of the meeting, based upon, at least in part, the one or more second summary tags, wherein the first summary and the second summary are distinct.

18. The computing system of claim 17, further comprising:
a fifth software module executed on the at least one processor and the at least one memory architecture, wherein the fifth software module is configured to retrieve at least one of: the first summary, and the second summary, based upon, at least in part, a position of at least one of: the first user, and the second user.

19. The computing system of claim 18, wherein the position of at least one of: the first user, and the second user, is based upon, at least in part, at least one of: a team association, an organizational hierarchy, a corporate directory, a social network, and a trust relationship.

20. The computing system of claim 17, further comprising:
a sixth software module executed on the at least one processor and the at least one memory architecture, wherein the sixth software module is configured to determine at least one of: the first interest level corresponding to the first user associated with the meeting, and the second interest level corresponding to the second user associated with the meeting.
